(19) United States
(12) Patent Application Publication
(10) Pub. No.: US 2011/0054959 A1
(43) Pub. Date: Mar. 3, 2011

(54) SYSTEM AND METHOD FOR A STANDARDS-BASED JOURNALISM MARKETPLACE

(75) Inventors: Gina EDWARDS, Naples, FL (US); Cathy Zollo, Sarasota, FL (US)

(73) Assignee: Watchdog City LLC, Naples, FL (US)

(21) Appl. No.: 12/546,936

(22) Filed: Aug. 25, 2009

(51) Int. Cl. G06Q 10/00; G06Q 30/00; G06Q 50/00

(52) U.S. Cl. 705/7; 705/30; 705/26.7

(57) ABSTRACT

A system and method for a standards-based journalism marketplace that allows entrepreneurial journalists to distinguish themselves as professionals operating under professional journalists' code of ethics and sell their content directly to the public. The standards-based journalism marketplace system may include a rating mechanism that allows the public audience to hold journalists accountable to standards of fairness, accuracy, and purity from conflicts of interest and corrupting advertising influences.

### FIELD OF THE INVENTION

The invention relates to an online standards-based journalism marketplace.

### BACKGROUND OF THE INVENTION

The explosion in the past decade of the delivery of news and information via the World Wide Web has led to a complete transformation of the economic model that has sustained American journalism and a free press for more than a century.

An advantage of the Web's media transformation is that now, more than ever, new and previously unheard voices can gather and share information across town or across the globe without the aid or interference of large media organizations.

The blogosphere has opened new channels to do the work that in the past has been the calling of journalists: holding power accountable. Web 2.0 technologies have blurred the lines between creators and consumers of news content and these technologies have invited the public to participate in unprecedented levels of dialogue.

And yet despite this digital information explosion, the counter-intuitive has occurred: Thousands of professional journalists have been laid off or abandoned their profession in the past 5 years as publicly-traded mega media companies have sought to satisfy Wall Street's profit demands amidst an ever-fragmenting advertising landscape.

Deep newsroom staffing cuts have forced editors and producers around the country to all but abandon investigative reporting and watchdog journalism along with a commitment to thorough coverage of the communities they serve. The number of reporters producing standards-based journalistic content that is free from the taints of conflicts of interest appears to be declining.

Many of journalism's best and brightest are sickened by the devastating effects of these economic pressures and publishers' reactionary blending of editorial and advertising content. In some smaller markets, indeed it appears that the news is for sale. While the public service contributions of some journalistic stars continue to standout, the horizon for quality journalism has grown dark. The health of American democracy is inextricably intertwined with investigative reporting and a healthy free press.

Many professional journalists who have left traditional media companies now find themselves struggling to create financially viable blogs or news portals supported by advertising that can replace a full-time income. This struggle comes even though many of these reporters and editors have built solid reputations for credibility and accuracy in the communities they serve. They are trusted brands.

Yet once out from under the old media banner, professional journalists find themselves heaped in with the noisy morass of bloggers who may or may not operate under professional journalists' standards. Conversely, no system or method exists for bloggers lacking old-media credentials to distinguish themselves as practicing independent standards-based journalism.

Also problematic is the difficult time the public audience has searching for and finding reporters doing bona fide journalism outside mainstream media outlets. The public audience is without a yardstick to measure credibility and trustworthiness in the blogosphere.

These and other drawbacks exist.

### SUMMARY OF THE INVENTION

The invention addressing at least some of these and other drawbacks relates to a system and method for a standards-based journalism marketplace that allows entrepreneurial journalists to distinguish themselves as professionals operating under professional journalists' code of ethics and sell their content directly to the public. The standards-based journalism marketplace system may include a rating mechanism that allows the public audience to hold journalists accountable to standards of fairness, accuracy, and purity from conflicts of interest and corrupting advertising influences. The standards-based journalism marketplace system may interact with a searchable database of content uploaded by users who seek to sell their content via digital downloads. Such content may comprise, but not be limited to, written text (for example, stories, news items, articles, and/or other written text), photographs, videos, audio podcasts, graphic illustrations, links to subscription-based searchable databases, and/or other content.

According to an aspect of the invention, users who wish to participate in the marketplace by selling, submitting (for sale or otherwise), viewing, and/or purchasing content may register as credentialed users or non-credentialed users. Credentialed users may include reporters, journalists, editors, photographers, videographers, graphic illustrators, journalism programmers, and/or credentialed users. Credentialed users may include users who wish to distinguish themselves as professionals who abide by the Code of Ethics of the Society of Professional Journalists (which is a standard recognized by journalists worldwide). Other journalist standards may be used.

According to one aspect of the invention; to sign-up as a credentialed user, the user may agree to terms which include, but are not limited to: an identity verification process; disclosure of work history; an agreement to avoid conflicts of interest, refuse gifts, favors, fees, free travel and special treatment; and shun or disclose secondary employment, political involvement (including making campaign donations of any kind), public office and service in community organizations, if they compromise or may tend or appear to compromise journalistic integrity. To participate in the marketplace as a credentialed user, the user may agree to the “Press Pass” voluntary credentialing terms and conditions specific to practicing journalists and swear the oaths that are included as part of the registration process. Other registration criteria may be used for credentialed users.

According to an aspect of the invention, non-credentialed users may include bloggers, readers, and/or other non-credentialed users. Non-credentialed users may include users who wish to participate in the marketplace but are not required to agree to abide by any Journalist standards, for example, the Code of Ethics of the Society of Professional Journalists. Non-credentialed users, for example, bloggers may participate in the marketplace by selling content associated with their commentaries and their expertise via, for example, online white papers, video tutorials and “how-to” content, and/or other content. Non-credentialed users, for example, readers may participate in the marketplace by viewing and/or purchasing, but not selling and/or submitting content. Non-credentialed users do not have to agree to uphold the tenants of Journalists standards, for example, Professional Journalists' Code of Ethics, that credentialed users do. To sign-up as a non-credentialed user, the user may pledge that they will not steal the work of others and that they will not copy, redistribute, share or otherwise violate copyright laws by allowing others to read, view or consume paid content from the marketplace without them first paying for it. Other registration criteria may be used for non-credentialed users.

A standards-based journalism marketplace system may comprise, among other things, at least one server communicatively connected to one or more network device associated with one or more credentialed users and/or one or more non-credentialed users, and/or other components. The server may comprise a processor, circuitry and/or other hardware operable to execute computer-readable instructions. According to one aspect of the invention, the server may include one or more computer-readable storage media configured to store one or more software modules, wherein the software modules include computer-readable instructions that when executed by the processor cause the processor to perform the functions described herein. According to one implementation, the server may be configured to host and/or operate a standards-based journalism marketplace website where users may buy and/or sell content. According to one implementation, the server may comprise computer hardware programmed with a computer application having one or more software modules that enable-the various features and functions of the invention. Non-limiting examples of the software modules in the application may include one or more of a credentialing module, a content management module, an e-commerce module, a credibility management module, and/or other modules, as described herein.

According to one implementation, the credentialing module may comprise one or more sub-modules for managing registration of credentialed/non-credentialed users to the website, creating and/or managing credentialed/non-credentialed user profiles, creating and/or managing credentialed/non-credentialed user accounts, performing identity verification, performing administrative functions, for example, enabling and/or disabling accounts, and/or performing other functions.

A registration module may manage the registration of credentialed, non-credentialed, and/or other users to the website. An account management module may enable management of account information, including for example, to create and/or manage accounts for credentialed, non-credentialed, and/or other users. A profile module may create and/or manage the profiles for credentialed, non-credentialed, and/or other users. A verification module may manage the identity verification process for users, including for example, users who desire to sign-up as credentialed users. An administrative module may perform and/or enable administrative functions, for example, enabling and/or disabling accounts, and/or other functions. A messaging module may allow users participating in the marketplace to send and/or receive messages.

According to one implementation, the content management module may comprise one or more sub-modules for managing content for use in the system, including for example, managing the uploading of content to the website, managing the searching and/or presentation of the uploaded content, and/or performing other content management functions.

An upload module may manage the uploading of content to the website. A search/presentation module may manage the searching and/or presentation of uploaded/purchased content.

According to one implementation, the E-commerce module may comprise one or more sub-modules for managing online transactions, including for example, the online payment for purchased content, calculating a final value fee for the credentialed/non-credentialed user who provided the purchased content, and/or performing other functions.

An online payment module may manage or facilitate the online payment for purchased content. A final value fee calculation module may calculate a final value fee for the credentialed/non-credentialed user who provided the purchased content.

According to one implementation, the Credibility management module may comprise one or more sub-modules for managing credibility of users and/or content, including for example, the rating of content provided by users (e.g., credentialed users, non-credentialed users, and/or other users), maintaining an overall rating score for the users who uploaded the content, tracking violations to the terms of use agreements, code of ethics, and/or any oaths and pledges taken by the users, and/or performing other functions. Ratings may be based on various criteria and ratings for credentialed users may be based on different criteria than non-credentialed users.

A rating module may manage the rating of content provided by users (e.g., credentialed users, non-credentialed users, and/or other users) based on differing criteria and maintain an overall rating score for the user who uploaded the content based on the rating.

A violations module may track violations to the terms of use agreements, code of ethics, oaths-and pledges taken by the users, and/or other violations.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a system for a standards-based journalism marketplace, according to an aspect of the invention.

FIG. 2 is an exemplary flowchart depicting operations performed by a credentialing module, according to an aspect of the invention.

FIG. 3 is an exemplary flowchart depicting operations performed by an upload module, according to an aspect of the invention.

FIG. 4 is an exemplary flowchart depicting operations performed by a search/presentation module, according to an aspect of the invention.

FIG. 5 is an exemplary flowchart depicting operations performed by an e-commerce module, according to an aspect of the invention.

FIG. 6 is an exemplary flowchart depicting operations performed by a credibility management module, according to an aspect of the invention.

FIGS. 7A-7E depict exemplary graphical user interfaces for registration of credentialed and/or non-credentialed users, according to an aspect of the invention.

### DETAILED DESCRIPTION OF THE INVENTION

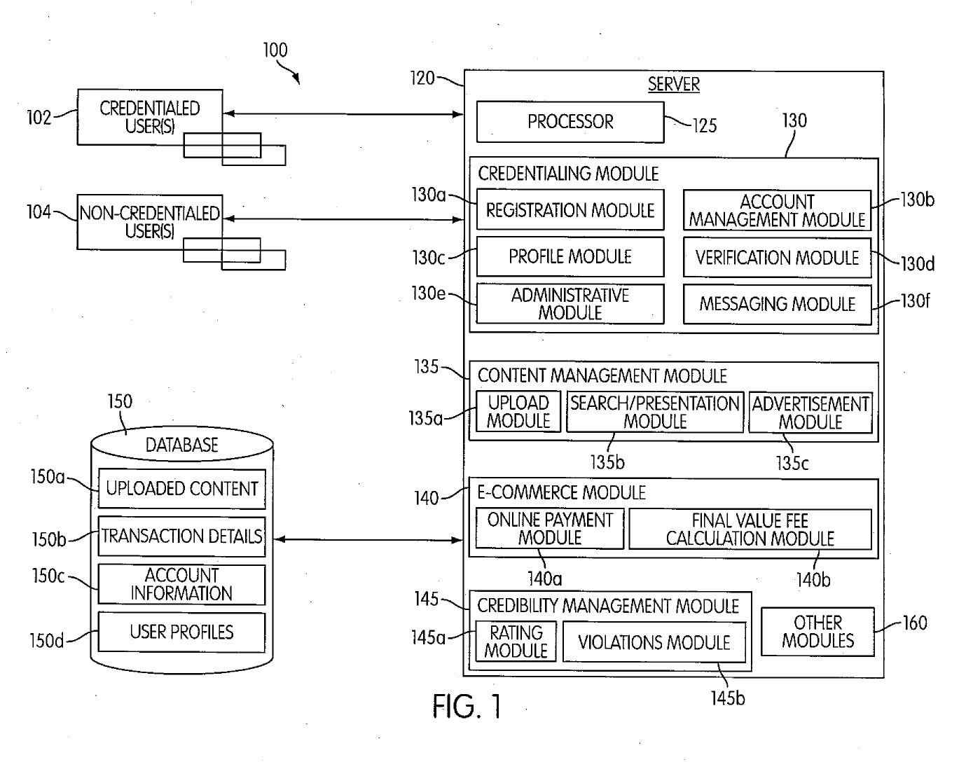

FIG. 1 illustrates an exemplary system 100 for an online standards-based journalism marketplace, according to one aspect of the invention. System 100 may comprise, among other things, at least one server 120 communicatively connected to one or more network devices associated with one or more credentialed users 102, one or more non-credentialed users 104, and/or one or more other users, and/or other components. Server 120 may comprise a processor 125, circuitry and/or other hardware operable to execute computer-readable instructions. According to one aspect of the invention, server 120 may include one or more computer-readable storage media configured to store one or more software modules, wherein the software modules include computer-readable instructions that when executed by the processor cause the processor to perform the various functions described herein.

According to one implementation, server 120 may be configured to host and/or operate an online standards-based journalism marketplace website where users may buy and/or sell content. According to an aspect, the online journalism marketplace website may be an online journalism auction marketplace website where users may bid for content and the content may be sold to the highest bidder. According to one implementation, server 120 may comprise computer hardware programmed with a computer application (not shown) having one or more software modules that enable the various features and functions of the invention. Non-limiting examples of the software modules may include one or more of a credentialing module 130, a content management module 135, an e-commerce module 140, a credibility management module 145, and/or other modules 160, as described herein.

According to one implementation, credentialing module 130 may comprise one or more sub-modules for managing registration of credentialed/non-credentialed users to the website, creating and/or managing credentialed/non-credentialed user profiles, creating and/or managing credentialed/non-credentialed user accounts, performing identity verification, performing administrative functions, for example, enabling and/or disabling accounts, and/or performing other functions.

Registration module 130a may manage registration of credentialed, non-credentialed, and/or other users to the website. According to one implementation, registration module 130a may perform operations comprising, for example, receiving user requests for registration, determining whether the user desires to sign-up as a credentialed or non-credentialed user, obtaining personal information from the user including, for example, name, date of birth, address/state, zip code, country, nearest metro area, contact information, and/or other personal information, obtaining a 10-year work history from a user who desires to sign-up as a credentialed user, determining whether a user who desires to sign-up as a credentialed user has agreed to uphold the tenants of Professional Journalists' Code of Ethics, determining whether a user who desires to sign-up as a non-credentialed user has accepted to abide by non-credentialed user terms relating to stealing, copying, redistributing, sharing or otherwise violating copyright laws, determining whether a user has accepted to abide by the universal terms of use agreement and privacy policy, registering the user as a credentialed and/or non-credentialed user, and/or other operations. Registration module 130a may present a graphical user interface to the users to enable the users to register with the website. The graphical user interface may comprise a registration webpage that enables a user to register by entering information, checking boxes to accept the various terms and conditions, and/or perform other operations.

According to an aspect of the invention, users who -wish to participate in the marketplace by selling, submitting (for sale or otherwise), viewing, and/or purchasing content may register as credentialed users or non-credentialed users. Credentialed users may include reporters, journalists, editors, photographers, videographers, graphic illustrators, journalism programmers, and/or credentialed users. Credentialed users may include users who wish to distinguish themselves as professionals who abide by the Code of Ethics of the Society of Professional Journalists (which is a standard recognized by journalists worldwide). Other journalist standards may be used.

According to one aspect of the invention, to sign-up as a credentialed user, the user may agree to “Press Pass” voluntary credentialing terms and conditions which include, but are not limited to: an identity verification process; disclosure of work history; an agreement to avoid conflicts of interest, refuse gifts, favors, fees, free travel and special treatment; and shun or disclose secondary employment, political involvement (including making campaign donations of any kind), public office and service in community organizations, if they compromise or may tend to compromise journalistic integrity. To participate in the marketplace as a credentialed user, the user may agree to the “Press Pass” voluntary credentialing terms and conditions which are specific to practicing journalists and swear the oaths that are included as part of the registration process. Other registration criteria may be used for credentialed users.

Users who wish to sign-up as credentialed users may be charged a nominal registration fee to cover costs of identity verification and “Press Pass” credentialing program For credentialed user registration, registration module 130a may obtain payment information from the user. Payment information may include, for example, credit card payment information, debit card payment information, PayPal account payment information, and/or other payment information. According to an aspect, during registration, users who wish to sign-up as credentialed users may also be asked to answer yes or no to whether they have ever been convicted of a felony. Users who answer yes may be further asked to disclose the offense in general terms. A felony conviction may not preclude participation in the marketplace.

According to an aspect of the invention, non-credentialed users may include bloggers, readers, and/or other non-credentialed users. Non-credentialed users may include users who wish to participate in the marketplace but are not required to agree to abide by any Journalist standards, for example, the Code of Ethics of the Society of Professional Journalists. Non-credentialed users, for example, bloggers may participate in the marketplace by selling content associated with their commentaries and their expertise via, for example, online white papers, video tutorials and “how-to” content, and/or other content. Non-credentialed users, for example, readers may participate in the marketplace by viewing and/or purchasing, but not selling and/or submitting content. Non-credentialed users do not have to agree to uphold the tenants of Journalists standards, for example, Professional Journalists' Code of Ethics, that credentialed users do. Non-credentialed users may pledge that they will not steal the work of others and that they will not copy, redistribute, share or otherwise violate copyright laws by allowing others to read, view or consume paid content from the marketplace without them first paying for it. Users who wish to sign-up as non-credentialed users may not be charged the nominal registration fee during registration.

Media pundits who back political candidates and who appear on paid candidate advertisements, accept gifts or donate money to political parties may register as non-credentialed users. Status as a big player in television, radio, or elsewhere may not equate to qualification as a credentialed user. Credentialed users, for example, agree to abide by the Code of Ethics of the Society of Professional Journalists which non-credentialed users are not required to uphold.

During the registration process, credentialed/non-credentialed users may agree to abide by the universal terms of use agreement and privacy policy, which may include an agreement to refrain from violating copyright laws and stealing and redistributing content without permission of the copyright owners, plagiarizing, posting adult content, engaging in hate crimes, using profanity, or engaging in deceptive, fraudulent or harassing behavior. The terms of use agreement may be subject to change as unforeseen business conditions warrant. During the registration process, credentialed/non-credentialed users may accept a standard privacy policy agreement.

According to an aspect of the invention, credentialed/non-credentialed users may be asked to create a user id for use on/access to the website. Registration module 130a may obtain information regarding a user id, a password, a secret question, an answer to the secret question, and/or other information that a user wishes to use. Registration module 130a may create a unique user id for each credentialed/non-credentialed user based on the obtained information. According to one aspect of the invention, registered members of the website may be able to click on the unique user id at any time to find out the real name of the user. This may promote civility and transparency in the marketplace.

Account management module 130b may enable management of account information, including for example, to create and/or manage accounts for the credentialed, non-credentialed, and/or other users. Credentialed/Non-credentialed user accounts may be created based on the information submitted by the users during registration. Account management module 130b may receive the information from registration module 130a to create the accounts. Account management module 130b may obtain additional information to be included in the account from the credentialed/non-credentialed user and/or other modules after registration. Account management module 130b may accordingly update the account for the credentialed/non-credentialed user. The types of accounts that account management module 130b may manage may include, a credentialed user account, a non-credentialed user account, and/other account types. The account types may have unrestricted access to purchase content. The account types may be mutually exclusive and restrict where on the website the user may post/upload content.

An account may include information regarding the account type (e.g., credentialed user account, non-credentialed user account, and/or other account type), account status (i.e., for example, whether the account is enabled/active or disabled/inactive), day and date indicating since when the user is a registered member, the unique user id of the user, a credibility rating score for the user, account balance, number of purchased items, number of posted/uploaded items, number of sold items, number of watched items, number of items being currently bid for and the respective bids, user profile, account history including details regarding transactions performed by the user in the marketplace, for example, time and date of when particular content was purchased, description of the purchased content, fees associated with the purchased content, price of purchase content, and/or other transactions, amount of credit available for the user to perform transactions in the marketplace, and/or other information. Account management module 130b may enable a user to view the account information via a webpage displayed in a graphical user interface associated with the network devices used to access the website. The graphical user interface may comprise a webpage that is displayed to the user with the account information.

Account management module 130b may maintain and/or track an account balance for a user. The user may credit the account balance by adding funds via for example, a credit card, a debit card, and/or other forms of payment. Account management module 130b may accordingly update the account balance to reflect the new credit. As the user participates in the marketplace, for example by, purchasing, submitting, and/or selling content, the account balance is accordingly updated based on the fees or prices associated with the uploading/selling/purchasing content. Account management module 130b may track these transactions and update the account balance accordingly.

Account management module 130b may obtain payment information from a user that may be used for payment of fees and/or price associated with the purchased content. Payment information may include, for example, credit card payment information, debit card payment information, PayPal account payment information, and/or other payment information.

According to an aspect, account management module 130b may enable a credentialed user who has sold content to donate to a journalism legal defense fund. Once the legal defense fund reaches a pre-determined threshold, a committee of member journalists may review applications for intervention and make decisions about allocating funds to other member journalists. Such intervention may be used to defend a libel action or to file a public records lawsuit seeking right to access.

Profile module 130c may create and/or manage profiles for the credentialed, non-credentialed, and/or other users. The profiles may include the information submitted by the * users during registration and/or any information added after registration. Profile module 130c receives at least a portion of the information maintained in a profile from registration module 130a. Profile module 130c may create the profiles based on the received information. Profile module 130c may obtain additional information to be included in the profile from the user after registration. Profile module 130c may accordingly update the profile for the user based on the additional information. For example, for a credentialed user, the profile may include the credentialed user's personal information, the credentialed user's 10-year work history, any conflicts of interest for the credentialed user, and/or other information. For a non-credentialed user, the profile may include non-credentialed user's personal information, photo, video, and audio and/or general bio write-ups for the non-credentialed user. The profile information for the users may be available for access/viewing by registered users of the website, via for example, a graphical user interface.

Verification module 130d may manage the identity verification process for users, for example, users who desire to sign-up as -credentialed users and/or users who have been registered as credentialed users. Verification module 130d may obtain/receive, for example, the user's personal information, payment information, and/or other information from registration module 130a to perform the identity verification. Once the identity of the user has been verified, a “Press Pass” credential may be issued to the user. Identity verification may be performed in a number of ways. In one implementation, the verification may be based on at least the user's personal/account information and payment information (for example, credit card). A check may be made to ensure that the payment information matches the name of the user. In one implementation, identity verification process may include phone verification in which a representative may contact the user by phone. Additional checks using commercial databases matching address and date of birth as well as verification of published material may be utilized. Once a “Press Pass” credential is issued and the user has obtained status as a credentialed user, the credentialed user may be able to post content for sale in areas of the web site that are designated as standards-based journalism or a “Journalists Bylines” area or “Above the fold.” Other areas of the website may be areas designated for non-credentialed users, such as, for example, bloggers, commentators or experts, which may be similar to the way in which a newspaper designates an “Op-ed” page. In addition, each item posted for sale by a credentialed user may contain a distinguishing icon or other feature so that a user can determine at a glance whether the content was produced by a credentialed user or a non-credentialed user.. In one implementation of the invention, the Press Pass credential may be portable and usable off the website. In this implementation, a credentialed user may, for an additional fee, use a Press Pass logo and widget on an outside website and the logo links back to the credentialed user's detailed profile and ratings on the marketplace. An additional mechanism to report violations may be included.

Administrative module 130e may perform and/or enable administrative functions, for example, enabling and/or disabling accounts. Non-credentialed user accounts may be automatically enabled upon creation. Credentialed user accounts, however, may be enabled after the identity verification process is completed by verification module 130d and the identity of the user has been verified. Violations of the universal terms of use-agreement may result in suspension of an account and prevent future use of the marketplace as a buyer or seller. Violations to the tenants of Professional Journalists' Code of Ethics may result in suspension of a credentialed user account and/or downgrading from a credentialed user account to a non-credentialed user account. Administrative module 130e may, based on the violations information, suspend and/or downgrade an account. Such status information of an account, for example, enabled, disabled, suspended, downgraded, and/or other status information may be used by account management module 130b to update the status information of the account for the user.

According to an aspect of the invention, messaging module 130f may allow users participating in the marketplace to send/receive messages. Messaging module 130f may send messages, receive messages and/or deliver messages. For example, a user may send/receive public or private tips or messages to/from another user. Messages may include, for example, questions about posted/uploaded content, and/or other messages. According to an aspect of the invention, user's profile or a webpage describing content uploaded by the user may include a link to send a tip or message to the user.

According to one implementation, content management module 135 may comprise one or more sub-modules for managing content for use in the system, including for example, managing the uploading of content to the website, managing the searching and/or presentation of the uploaded/purchased content, managing the posting of advertisements by users participating in the marketplace, and/or performing other functions.

Upload module 135a may manage the uploading of content to the website. Upload module 135a may present a graphical user interface to a user (e.g., credentialed user/non-credentialed user) that enables the user to upload the content and specify one or more properties associated with the content and/or how the content is to be listed for sale in the marketplace. The graphical user interface may comprise a webpage that provides options to the credentialed/non-credentialed user to upload content and specify the properties.

Upload module 135a may receive content to be uploaded from a credentialed/non-credentialed user. Upload module 135a may provide the credentialed/non-credentialed user an option to attach files for the content. For instances where the content may be written text, upload module 135a may provide the credentialed/non-credentialed user another option to include the written text directly into an area defined in the webpage that can accept the written text. Upload module 135a may enable a credentialed user to label his content as reporter/journalistic content to distinguish from other content. Upload module 135a may receive one or more properties associated with the content and/or how the content is to be listed for sale in the marketplace from the credentialed/non-credentialed user. Upload module 135a may associate a user id identifying the credentialed/non-credentialed user who uploaded the content with the content. Upload module 135a may direct storage of the uploaded content and the properties associated with the content to uploaded content database 150a. Upload module 135a may list the uploaded content for sale in the marketplace based on the properties provided by the credentialed/non-credentialed user. Upload module 135a may create a content listing for the content in the marketplace. In one implementation, a copy of the content will be saved for future commercial use as an archive. The content listing may comprise an overview of the content, a link for detail description of the content, price of the content, an indicator identifying the content as an instant purchase item or a bidding item, and/or other information.

According to an aspect of the invention, credentialed/non-credentialed users who list the content for sale may pay a listing fee to participate in the marketplace. When a credentialed/non-credentialed user uploads content and lists the content for sale, upload module 135a may deduct a listing fee from the respective user's account balance. According to one aspect, upload module 135a may communicate with account management module 130b to deduct a listing fee from the respective user's account balance and update the account balance accordingly. Upload module 135a may list the content for sale in the marketplace after the listing fee has been paid.

Upload module 135a may enable a credentialed user/non-credentialed user uploading the content to specify one or more properties associated with the content and/or how the content is to be listed for sale in the marketplace during the content uploading process. The one or more properties may comprise, but not be limited to, the content type (e.g., written text, video, photo, etc.), the price of the content, access permissions for the content, user id of user who uploaded the content, a location/geographic area and beat (e.g., investigations, cops and courts, schools, local government, GA, business, science and environment, sports, comic section, and/or other beats) where the content fits in best, a title for the content, an overview of the content which may include a brief summary regarding the content, a detailed description of the content, whether the content is to be listed for instant purchase without bidding or is to be listed for bidding, a minimum and maximum bid for content that is to be listed for bidding, whether the content is to be randomly selected to be displayed on front page as a featured item in the marketplace, whether the content listing is to be featured above other items in the category listings of the marketplace, whether the content listing is to be highlighted, for example, in a particular color to make the listing stand out from the other listings in the marketplace, the duration for which the content is to be listed in the marketplace, whether the content is to be re-listed automatically, whether identity of the users bidding on the content is to be hidden from the public to avoid rival sellers from contacting them and offering similar products or services, and/or other properties.

Upload module 135a may manage the listing of the uploaded content for sale in the marketplace based on the properties provided by the credentialed user/non-credentialed user. For example, the marketplace may have a number of categories (e.g., beats, city desks, and/or other categories) within which the uploaded content may be categorized and upload module 135a may categorize and place the content listing/content in an appropriate category. Upload module 135a may, for example, list the content as an instant purchase item or a bidding item. Upload module 135a may, for example, track the time for which the content has been listed, and may automatically re-list the content if the duration for which the content is to be listed has expired and the content has not been purchased.

Search/Presentation module 135b may manage the searching and/or presentation/display of uploaded/purchased content. Once the content has been uploaded by seller users (e.g. credentialed users, non-credentialed users, and/or other users who wish to sell content), other users (e.g. credentialed users, non-credentialed users, and/or other users who wish to browse for and/or purchase content) may browse through the uploaded content listings and/or request to search for desired content. Search/Presentation module 135b may present a webpage that may display various content listings, various categories for the content listings, and/or other listings and may allow other users to browse through the content listings and/or categories of the content listings. When a user clicks on a content listing, search/presentation module 135b may display a webpage which describes the content in detail. The webpage may display, a detailed description of the content, the price of the content, the number of bids for the content listed for bidding, the current bid for the content listed for bidding, an option to submit a bid for the content listed for bidding, an option to purchase the content listed for an instant purchase, and/or other information associated with the content. The Webpage may include a link to see other items for sale by the same seller user who uploaded the content or to see a detailed credibility rating of the seller user who uploaded the content.

Search/Presentation module 135b may present the content listings and/or content to other users according to the one or more properties specified by the seller users when the content is uploaded. For example, if the seller user specifies that the content is to be randomly selected to be displayed on front page as a featured item in the marketplace, search/presentation module 135b may accordingly display the content/content listing on the front page as a featured item. If the seller user specifies that the content listing is to be featured above other items in the category listings of the marketplace, search/presentation module 135b may accordingly display the content listing above other items in the appropriate category listing. If the seller user specifies that the content listing is to be highlighted, search/presentation module 135b may accordingly display a highlighted content listing. If the seller user specifies that the identity of the other users bidding on the content is to be hidden from the public, search/presentation module 135b may accordingly present the content listings and/or content without displaying the identity of the bidders.

According to an aspect of the invention, search/presentation module 135b may present a “Press Pass” icon or a “Non-credentialed” icon beside a displayed content listing/displayed content. A “Press Pass” icon may indicate that the content is uploaded/listed by a credentialed user. A “Non-credentialed” icon may indicate that the content is uploaded/listed by a non-credentialed user.

The webpage presented by search/presentation module 135b may allow other users to specify one or more parameters for the search by, for example, entering keywords in a search dialog box, selecting from options provided a drop down box, selecting from options associated with check boxes, and/or other mechanisms for specifying parameters. The one or more parameters may include, account type (for example, search by credentialed/non-credentialed user), beats (for example, search by a particular beat), keywords in title and/or description, geographic location, and/or other parameters. Search/presentation module 135b may receive the search request and perform a search of the uploaded content database 150a for the content that a user desires based on the search parameters. For example, the user may specify that he desires content uploaded/listed by credentialed users only. In this case, search/presentation module 135b may first query the account information database 150c to obtain the unique user ids for credentialed users which have a credentialed user account type. Then, the search/presentation module 135b may perform a search of the uploaded content database 150a to identify content that has been uploaded/listed by the credentialed users having the obtained user ids. Search/presentation module 135b may display the search results to the user who is searching for desired content.

According to an aspect, search/presentation module 135b may receive a selection of desired content from the user. The user may select desired content from the search results and/or while browsing the content listings. In response to the selection, search/presentation module 135b may process the selection and present an option to either purchase the content listed for instant purchase or submit a bid for the content listed for bidding. Processing the selection may comprise identifying a user id associated with the seller user who uploaded the selected content determining whether to present an option to purchase the content or an option to submit a bid for the content based on the properties specified by the seller user when the content is uploaded, and/or other operations.

According to an aspect, search/presentation module 135b may receive a purchase request from a buyer user (i.e., credentialed, non-credentialed, and/or other user who has browsed/searched for and found content he/she wishes to purchase) to purchase the selected content that was uploaded by the seller user. Search/presentation module 135b may notify e-commerce module 140 of the purchase request. Search/presentation module 135b may send the purchase request to e-commerce module 140 for payment processing. The purchase request may include the user id of the buyer user and/or the seller user.

According to an aspect, search/presentation module 135b may receive a bid submitted by the buyer user. Search/presentation module 135b may update the webpage to display the submitted bid and may notify the account management module 130b so that the account associated with the buyer user and/or seller user can be accordingly updated.

According to one implementation, the marketplace may include a “newsroom” which is an online gathering area for credentialed, non-credentialed and/or other users. Advertisement module 135c may allow credentialed users to post a help wanted advertisement for collaboration or “team coverage” on stories/projects. For example, a credentialed user may want to advertise to hire an editor to edit his or her project. Each of the parties may in turn privately work out the conditions of compensation or partnership for selling in the marketplace. The marketplace provides an opportunity for site members to find each other. Similarly, a non-credentialed user may want to post “service for sale”. The newsroom may also contain educational content regarding news gathering techniques, public records laws, journalism history, and/or other content of interest.

According to one implementation, E-commerce module 140 may comprise one or more sub-modules for managing online transactions, including for example, the online payment for purchased content, calculating a final value fee for the credentialed/non-credentialed user who uploaded the purchased content, and/or performing other functions.

Online payment module 140a may manage or facilitate the online payment for purchased content and the secure viewing of the purchased content in response to the payment receipt and/or verification. Online payment module 140a may receive the purchase request from a buyer user. Online payment module 140a may process the purchase request by deducting the price of the purchased content from the buyer user's account balance. According to an aspect, online payment module 140a may process the purchase request by using the buyer user's previously provided payment information. According to an aspect, online payment module 140a may process the purchase request by using the buyer user's currently provided payment information. Payment information may include, for example, credit card payment information, debit card payment information, PayPal account payment information, and/or other payment information.

According to an aspect, online payment module 140a may be notified that the duration for which the content is to be listed in the marketplace has expired. If the content is listed for bidding, in response to such notification, online payment module 140a may receive a purchase request for the content and may automatically charge the price of the purchased content to the buyer user with the highest bid. Online payment module 140a may charge the buyer user by deducting the price of the purchased content from the buyer user's account balance. According to an aspect, online payment module 140a may charge the buyer user by using the buyer user's previously provided payment information. According to an aspect, online payment module 140a may charge the buyer user by using the buyer user's currently provided payment information. Online payment module 140a may receive the notification from upload module 135a.

According to an aspect, upon payment verification, online payment module 140a may authorize secure access to the purchased content for the buyer user. The purchased content may be received for viewing in a secure area of the website from which it cannot be copied (for example, right-click copying may be disabled). According to an aspect, upon payment verification, the buyer user may be given access to a link to the secure viewing area to view the content. Included will be options for the buyer user to send a link to the content to others, but those others would also have to register and purchase the content for secure viewing on a section of the website from which the content cannot be copied. In some instances, a download may be triggered in response to payment verification. The content may be made available in a variety of file formats depending on the purchased content type. It will be understood that the website may provide the appropriate plug-ins to be able to view content of different types.

According to one implementation, online payment module 140a may notify search/presentation module 135b of the authorization of secure access to the purchased content. Search/presentation module 135b may accordingly manage the secure display, access, and/or download of the purchased content.

According to one implementation, e-commerce module 140 may direct the storage of transaction details regarding the purchase of uploaded content (for example, time and date of when the content was purchased, description of the purchased content, fees associated with the purchased content, price of purchase content, and/or details) to a transaction details database 150c.

Final value fee calculation module 140b may calculate a final value fee that is to be paid to the marketplace by the seller-user whose content was purchased by the buyer user.

According to an aspect, a seller user may list his content for sale so as to sell his content directly to the public. Buyer users, using-online payment accounts like PayPal, may purchase the content directly from the seller user selling his content and also pay the seller user directly via, for example, online payment module 140a. In this case, the seller user may pay a listing fee when he lists/uploads the content. When content sells to other buyer users, the seller user may pay a final value fee to the marketplace. Final value fee calculation module 140b may calculate the final value fee based on the number of sales, price of the content sold, and/or other criteria.

A seller user may pay a monthly subscription fee to the marketplace and upload/list content to an online Newsstand store. For the monthly subscription fee, the system may provide a seller user with access to a set of pages which the seller user may personalize and use exclusively for uploading/listing his/her content. Upload module 135a may manage the uploading of the content to the online Newsstand store. The seller user may specify whether the content is to be listed in as a regular content listing (for example, regular auction listing) or as a listing in the seller user's newsstand store. In this case, a seller user may or may not pay the listing fee. A link may be provided in the seller user's profile to “See seller's newsstand.” When content sells to other buyer users, the seller user may pay a percentage of the final value fee for each sale. Final value fee calculation module 140b may calculate the final value fee based on the number of sales, price of the content sold, and/or other criteria. Administrative module 130e may enable adjustment of fees based on the length of subscription. The newsstand may specify if the user is a credentialed user or a non-credentialed user.

Online payment module 135a and final value fee calculation module 135b may notify the account management module 130b so that the account associated with the buyer user and/or seller user can be accordingly updated. For example, the account may be updated to reflect the number of purchased/sold items, the account balance in view of the fees and/or purchases applied, and/or other information.

According to one implementation, Credibility management module 145 may comprise one or more sub-modules for managing credibility of users and/or content, including for example, the rating of content provided by users (e.g., credentialed users, non-credentialed users, and/or other users), maintaining an overall rating score for the users who uploaded the content, tracking violations to the terms of use agreements, code of ethics, and/or any oaths and pledges taken by the users, and/or performing other functions. Ratings may be based on various criteria and ratings for credentialed users may be based on different criteria than non-credentialed users.

Rating module 145a may manage the rating of content provided by users (e.g., credentialed users, non-credentialed users, and/or other users) based on differing criteria and maintain an overall credibility rating score for the user, for example, seller user who uploaded the content based on the rating.

According to an aspect, rating module 145a may prompt a buyer user who purchased content from the website to rate the purchased content. Rating module 145a may make a determination whether the purchased content was uploaded/listed by a credentialed seller user or a non-credentialed seller user.

In response to a determination that the purchased content was uploaded/listed by a credentialed seller user, the buyer user may be prompted to rate the content based on one or more parameters including, but not limited to, relevance of the content, technical and/or factual accuracy of the content, an understanding of the code of ethics, and/or other parameters. A buyer user may have access to the code of ethics that the credentialed user has agreed to abide by. A buyer user may receive or be provided with information about the sacrifices credentialed users make to remain independent and taint free from conflicts of interest during registration (e.g., via registration module 130a) or otherwise. A buyer user may then be able to rate the content based on this understanding. According to an aspect, the buyer user may be prompted to rate according to a multi-point rating survey including the one or more parameters. Rating module 145a may prompt the buyer user to rate the purchased content on his account page and/or via email including a link to the survey.

In response to a determination that the purchased content was uploaded/listed by a non-credentialed seller user, the buyer user is prompted to rate the content based on one or more parameters including, but not limited to, relevance of the content, technical and/or factual accuracy of the content, and/or other parameters. Content uploaded by non-credentialed seller users may not be rated based on the understanding of the code of ethics. According to an aspect, the buyer user may be prompted to rate according to a multi-point rating survey including the one or more parameters. Rating module 145a may prompt the buyer user to rate the purchased content on his account page and/or via email including a link to the survey.

In one implementation, rating module 145a may offer a section for a buyer user to provide comments/reviews/feedback beyond the ratings. A credentialed/non-credentialed seller user may respond to negative criticism and comments. All this information may be made available to users of the website prior to buying the content, though no user may rate or comment on the content without first buying it.

Rating module 145a may maintain an overall credibility rating score for credentialed/non-credentialed seller users who uploaded the purchased content. The overall rating score may be based on the number of sales, the ratings/feedback they receive, and/or other parameters. For example, negative comments may result in a decrease in the overall credibility rating score for credentialed/non-credentialed seller users. These ratings/score may serve as a guide for other buyers trying to decide whether or not to purchase the content.

In order to maintain status as a credentialed user, the user should maintain a sufficient overall credibility rating score. The overall credibility rating score may include an accuracy feedback score which is based on number of corrections required to the purchased content in response to buyer feedback and number of postings by a buyer regarding factual inaccuracies. Credentialed user account may be suspended, downgraded and/or terminated based on the number of corrections the credentialed user has to post to the marketplace in a given period. This may apply to a non-credentialed user as well, however, the standard for a non-credentialed user may be lower than a credentialed user because the non-credentialed user is not required to uphold the Code of Ethics or other journalist standards.

Account management module 130b and administrative module 130e may, based on this information from the rating module 145a, update the credibility rating score for a user, and/or suspend, downgrade, and/or terminate an account and update the account status.

Violations module 145b may track violations to the terms of use agreements, code of ethics, and/or any oaths and pledges taken by users participating in the marketplace (e.g., credentialed users, non-credentialed users, and/or other users). Violations module 145b may receive reports from users regarding violations including, but not limited to, plagiarism or copyright violations, for example, re-distributing purchased content and giving it away for free to others.

Violations of the universal terms of use agreement may result in suspension of an account and prevent future use of the marketplace as a buyer or seller. Violations to the tenants of Professional Journalists' Code of Ethics may result in suspension of a credentialed user account and/or downgrading from a credentialed user account to a non-credentialed user account. Administrative module 130e may, based on the violations information from the violations module 145b, suspend and/or downgrade an account.

According to one implementation, server 120 may be coupled to/interfaced with one or more databases 150. Databases 150 may comprise an uploaded content database 150a, a transaction details database 150b, an account information database 150b, a user profile database 150d, and/or other databases.

Content uploaded by credentialed/non-credentialed users, and the one or more properties associated with the content and/or how the content is to be listed for sale in the marketplace may be stored in an uploaded content database 150a. According to one implementation, content management module 135 may direct the storage of this information to the uploaded content database 150a.

In one implementation, a transaction details database 150b may store transaction details regarding the purchase of uploaded content. According to one implementation, e-commerce module 140 may direct the storage of the transaction details to the transaction details database 150b.

In one implementation, account information for various users (e.g., credentialed, non-credentialed, and/or other users) may be stored in account information database 150c. According to one implementation, account management module 130b may direct the storage of the account information to account information database 150c.

In one implementation, user profile database 150d may store registration/profile information gathered, for example, during and/or after the registration of various users. The credentialing module 130 may direct storage of the registration/profile information to the user profile database 150d.

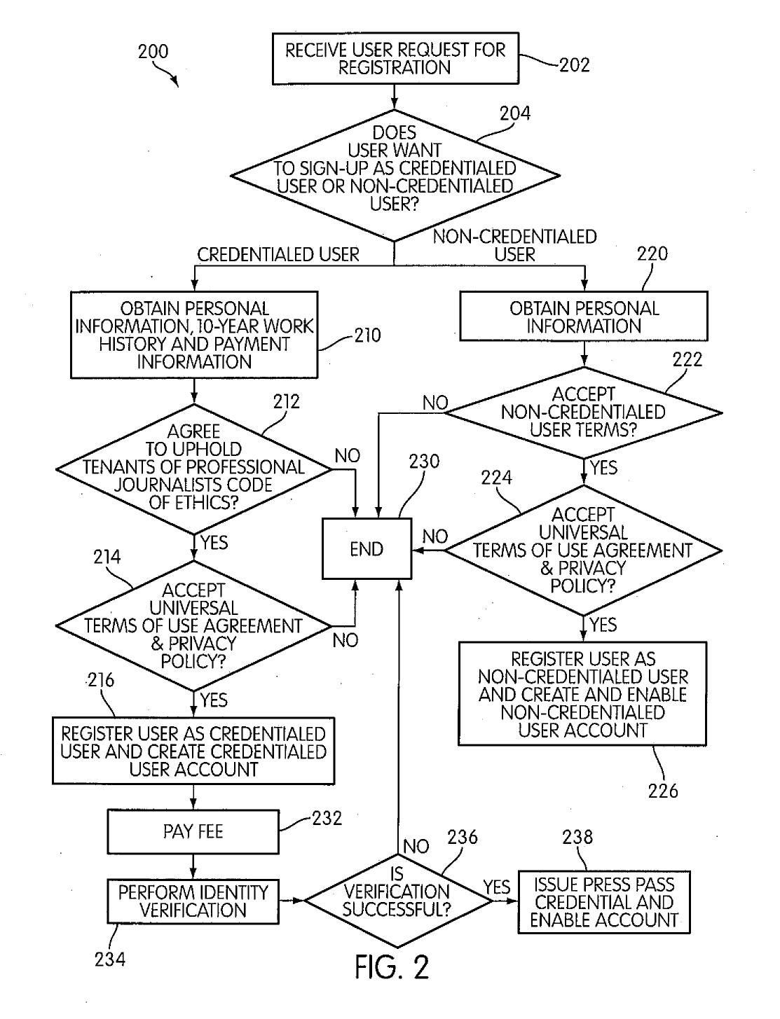

FIG. 2 illustrates an exemplary flowchart 200 of at least some processing operations performed by a credentialing module 130, according to an aspect of the invention. The described operations may be accomplished using one or more of the sub-modules of the credentialing module 130 and in some implementations, various operations may be performed in different sequences. In other implementations, additional operations may be performed along with some or all of the operations shown in FIG. 2. In yet other implementations, one or more operations may be performed simultaneously. In yet other implementations, one or more of operations may not be performed. Accordingly, the operations described are exemplary in nature and, as such, should not be viewed as limiting.

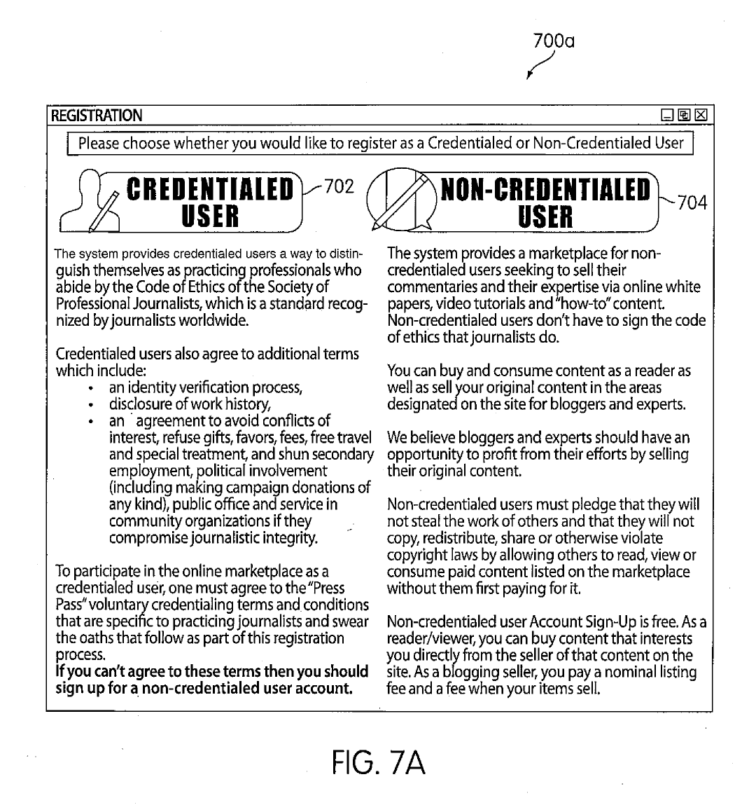

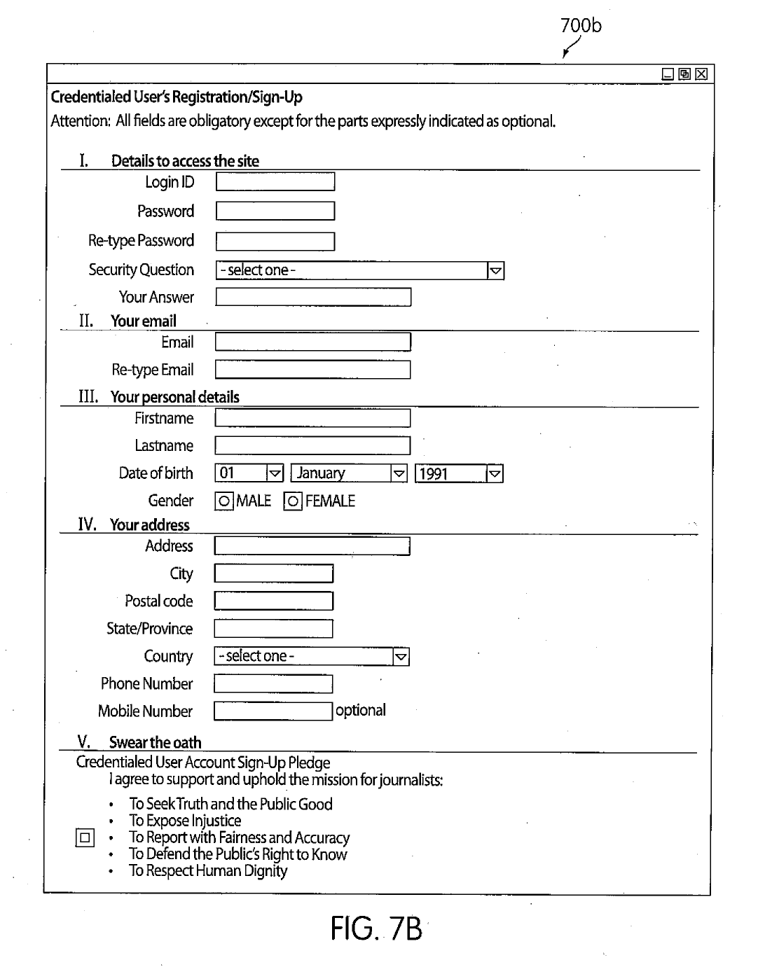

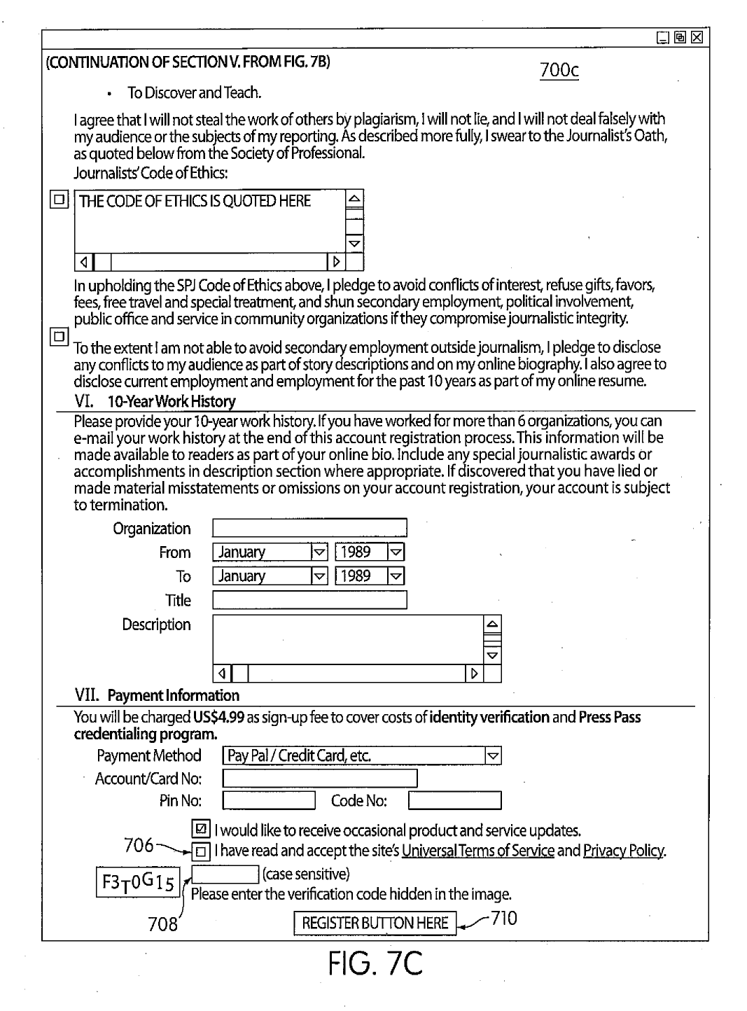

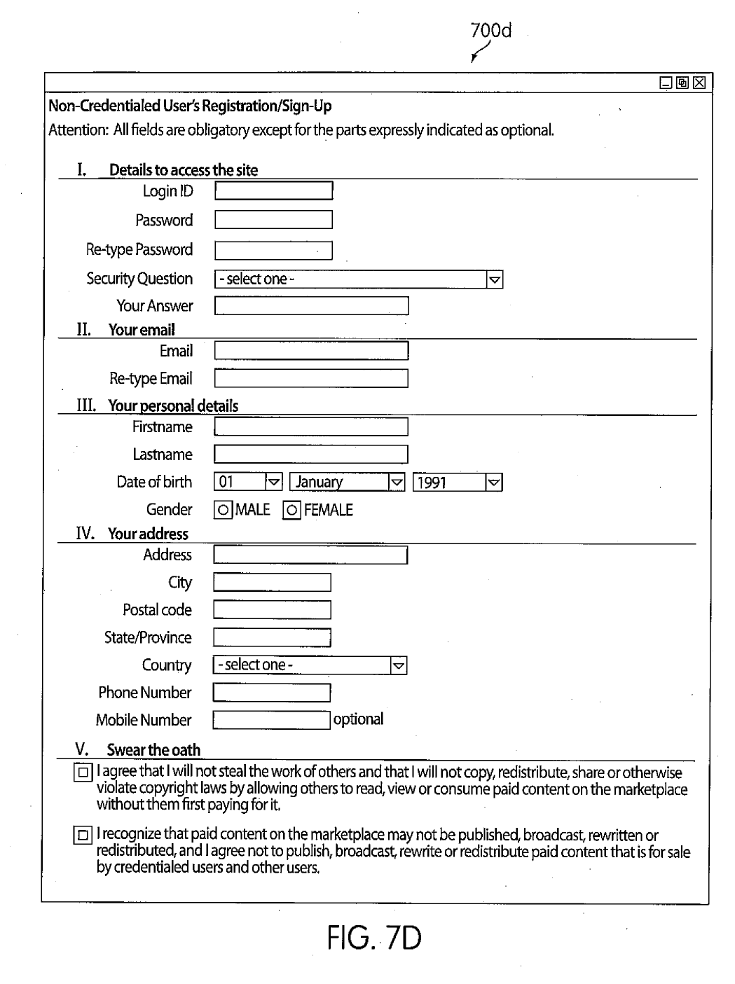

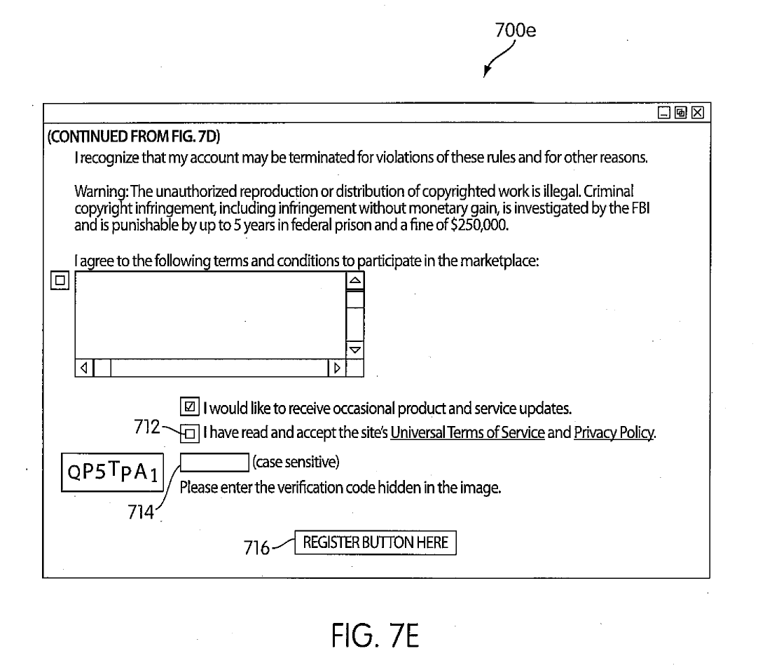

In operation 202, a user request for registration is received. In operation 204, a determination is made whether the user desires to sign-up as a credentialed or non-credentialed user. For example, if a user selects a credentialed user button (for example, as shown in FIG. 7A), a determination is made that the user desires to sign-up as a credentialed user. Similarly, if a user selects a non-credentialed user button (for example, as shown in FIG. 7A), a determination is made that the user desires to sign-up as a non-credentialed user.

In response to a determination that a user desires to sign-up as a credentialed user, a credentialed user registration and credentialing process may be performed by performing one or more of the operations 210, 212, 214, 216, 232, 234, 236, 238, and/or other operations. In response to a determination that a user desires to sign-up as a non-credentialed user, a non-credentialed user registration process may be performed by performing one or more of the operations 220, 222, 224, 226, and/or other operations.

In response to a determination that a user desires to sign-up as a credentialed user, personal information, a 10-year work history, and/or payment information is obtained from the user in operation 210.

In operation 212, a determination is made whether the user who desires to sign-up as a credentialed user has agreed to uphold the tenants of Professional Journalists' Code of Ethics.

In response to a determination that the user has agreed to uphold the tenants of Professional Journalists' Code of Ethics, a determination is made whether the user who desires to sign-up as a credentialed user has accepted to abide by the universal terms of use agreement and privacy policy in operation 214. In response to a determination that the user has not agreed to uphold the tenant of Professional Journalists' Code of Ethics, the user receives a cannot proceed message and processing ends in operation 230.

In response to a determination that the user who desires to sign-up as a credentialed user has accepted to abide by the universal terms of use agreement and privacy policy, the user is registered as a credentialed user and a credentialed user account is created in operation 216. In response to a determination that the user who desires to sign-up as a credentialed user has not accepted to abide by the universal terms of use agreement and privacy policy, the user receives a cannot proceed message and processing ends in operation 230.

In operation 232, a nominal registration fee may be received from the credentialed user.

In operation 234, the identity of the credentialed user may be verified based on for example, the payment information and the personal information received from the credentialed user.

In operation 236, a determination is made whether the identity verification is successful. In response to a determination that the identity verification is successful, a “Press Pass” credential may be issued to the credentialed user and the credentialed user account may be enabled in operation 238. According to an aspect of the invention, operations 232, 234, and 236 may be performed prior to operation 216. In other words, the user may be registered as a credentialed user, a credentialed user account may be created and enabled, in response to the determination that the identity verification is successful.

In response to a determination that the identity verification is unsuccessful, the “Press Pass” credential may not be issued to the credentialed user, the credentialed user account may not be enabled and the processing may end in operation 230.

In response to a determination that a user desires to sign-up as a non-credentialed user, personal information is obtained from the user who desires to sign-up as a non-credentialed user in operation 220.

In operation 222, a determination is made whether the user who desires to sign-up as a non-credentialed user has accepted to abide by the non-credentialed user terms that he will not steal the work of others and that he will not copy, redistribute, share or otherwise violate copyright laws by allowing others to read, view or consume paid content from the marketplace without them first paying for it.

In response to determination that the user has accepted the non-credentialed user terms, determination is made whether the user who desires to sign-up as a non-credentialed user has accepted to abide by the universal terms of use agreement and privacy policy in operation 224. In response to a determination that the user has not accepted the non-credentialed user terms, the user receives a cannot proceed message and processing ends in operation 230.

In response to a determination that the user has accepted to abide by the universal terms of use agreement and privacy policy, the user is registered as a non-credentialed user and a non-credentialed user account is created and enabled in operation 226. In response to a determination that the user has not accepted to abide by the universal terms of use agreement and privacy policy, the user receives a cannot proceed message and processing ends in operation 230.

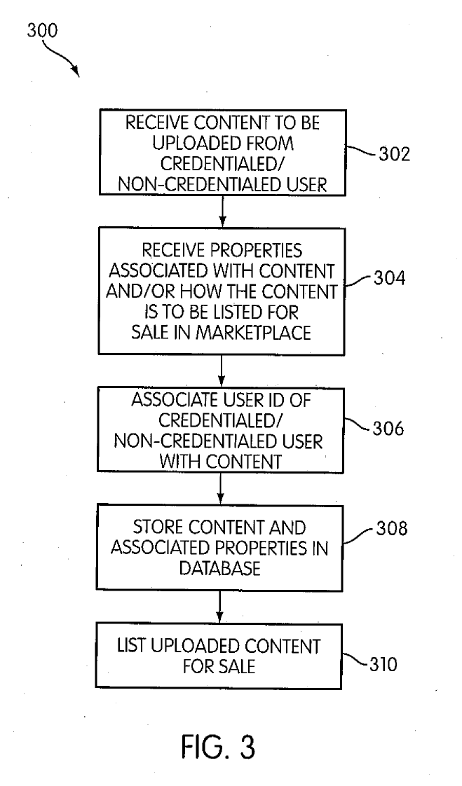

FIG. 3 is an exemplary flowchart 300 of at least some processing operations performed by an upload module 140a, according to an aspect of the invention. In some implementation, the described operations may be performed in different sequences. In other implementations, additional operations may be performed along with some or all of the operations shown in FIG. 3. In yet other implementations, one ore more operations may be performed simultaneously. In yet other implementations, one or more of operations may not be performed. Accordingly, the operations described are exemplary in nature and, as such, should not be viewed as limiting.

In operation 302, content to be uploaded may be received from a credentialed/non-credentialed user.

In operation 304, the one or more properties associated with the content and/or how the content is to be listed for sale in the marketplace are received from the credentialed/non-credentialed user.

In operation 306, the received content may be associated with a user id of the credentialed/non-credentialed user who uploaded the content.

In operation 308, the content and the associated properties may be stored/uploaded in the uploaded content database 150a.

In operation 310, the uploaded content may be listed for sale in the marketplace based on one or more of the properties provided by the credentialed/non-credentialed user.

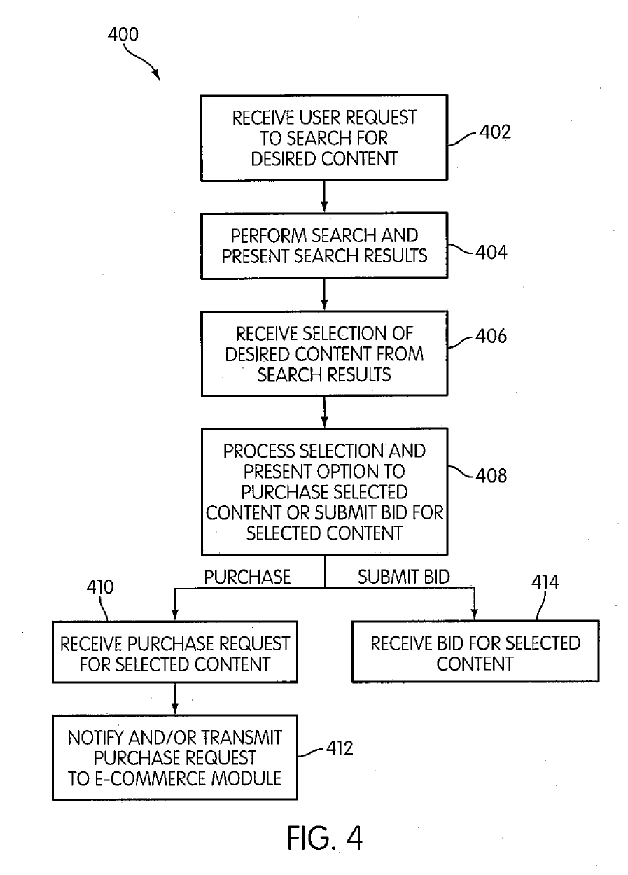

FIG. 4 is an exemplary flowchart 400 of at least some processing operations performed by a search/presentation module 135b, according to an aspect of the invention. In some implementation, the described operations may be performed in different sequences. In other implementations, additional operations may be performed along with some or all of the operations shown in FIG. 4. In yet other implementations, one ore more operations may be performed simultaneously. In yet other implementations, one or more of operations may not be performed. Accordingly, the operations described are exemplary in nature and, as such, should not be viewed as limiting.

In operation 402, a user request to search for desired content may be received from a credentialed/non-credentialed buyer user.

In operation 404, a search of the uploaded content database 150a may be performed for content that the buyer user desires. According to one implementation, the buyer user may be presented with an option to enter keywords regarding the desired content (for example, in a search dialog box), and the search may be triggered for the content. The search results may be presented to the buyer user.

In operation 406, a user selection for the desired content from the search results may be received from the buyer user.

In operation 408, in response to the user selection, the selection may be processed. Processing of the selection may comprise identifying a user id associated with a credentialed/non-credentialed seller user who uploaded the selected content, determining whether to present an option to purchase the content or an option to submit a bid for the content based on the properties specified by the seller user when the content is uploaded, and/or performing other operations. An option to purchase the selected content or submit a bid for the selected content may be presented to the buyer user. For example, an option to purchase the selected content may be presented in response to a determination that the selected content has been listed as an instant purchase item. An option to submit a bid for the selected content may be presented in response to a determination that the selected content has been listed a bidding item.

In operation 410, a purchase request for the selected content may be received from the buyer user.

In operation 412, e-commerce module 140 may be notified of the purchase request. In one implementation, the purchase request may be transmitted to the e-commerce module 140.

In operation 414, a bid submitted by the buyer user for the selected content may be received.

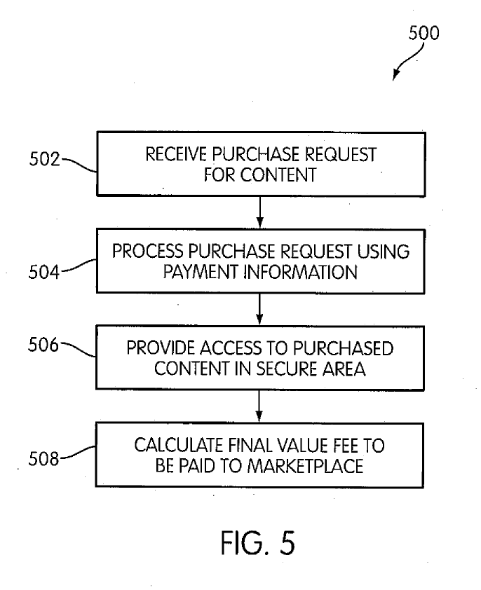

FIG. 5 is an exemplary flowchart 500 of at least some processing operations performed by an e-commerce module 140, according to an aspect of the invention. The described operations may be accomplished using one or more of the sub-modules of the e-commerce module 140 and, in some implementations, various operations may be performed in different sequences. In other implementations, additional operations may be performed along with some or all of the operations shown in FIG. 5. In yet other implementations, one ore more operations may be performed simultaneously. In yet other implementations, one or more of operations may not be performed. Accordingly, the operations described are exemplary in nature and, as such, should not be viewed as limiting.

In operation 502, a purchase request for uploaded content is received from a buyer user.

In operation 504, the purchase request is processed using payment information associated with the buyer user requesting the purchase.

In operation 506, authorization for access and/or access to the purchased content is provided to the buyer user, for example, in response to payment verification. Access to the purchased content may be provided in a secure viewing area of the website.

In operation 508, a final value fee that is to be paid to the marketplace by a seller user whose content has been purchased by the buyer user is calculated.

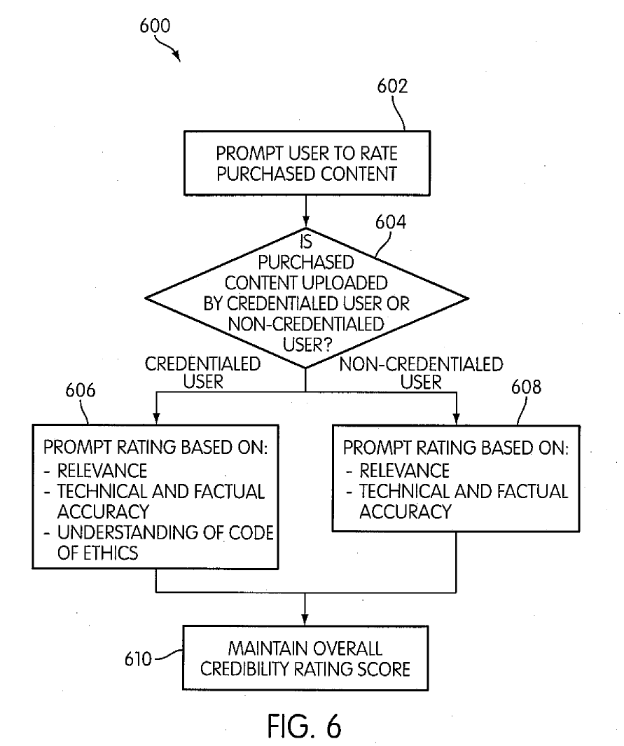

FIG. 6 is an exemplary flowchart 600 of processing operations performed by a credibility management module 145, according to an aspect of the invention. The described operations may be accomplished using one or more of the sub-modules of the credibility management module 145 and, in some implementations, various operations may be performed in different sequences. In other implementations, additional operations may be performed along with some or all of the operations shown in FIG. 6. In yet other implementations, one ore more operations may be performed simultaneously. In yet other implementations, one or more of operations may not be performed. Accordingly, the operations described are exemplary in nature and, as such, should not be viewed as limiting.

In operation 602, a buyer user who purchased content from the website is prompted to rate the purchased content.

In operation 604, a determination is made whether the purchased content was uploaded by a credentialed or a non-credentialed seller user. In response to a determination that the purchased content was uploaded by a credentialed seller user, in operation 606, the buyer user who purchased content is prompted to rate the content based on one or more parameters, for example, relevance, technical and/or factual accuracy, an understanding of the code of ethics, and/or other parameters.

In response to a determination that the purchased content was uploaded by a non-credentialed seller user, in operation 608, the buyer user who purchased content is prompted to rate the content based on one or more parameters, for example, relevance, technical and/or factual accuracy, and/or other parameters.

In operation 610, an overall credibility rating score for the seller user who uploaded the content is maintained based on the rating.

FIGS. 7A-7E depict exemplary graphical user interfaces for registration of credentialed and non-credentialed users, according to an aspect of the invention. FIG. 7A depicts a graphical user interface 700a enables a user to choose whether he/she wants to register as a credentialed user or a non-credentialed user. A user who desires to sign-up as a credentialed user may click on the credentialed user button 702 and a user who desires to sign-up as a non-credentialed user may click on the non-credentialed user button 704. Under credentialed user button 702 is provided a summary of requirements for the credentialed user to be able to register and participate in the marketplace. Under the non-credentialed user button 704 is provided a summary of requirements for the non-credentialed user to be able to register and participate in the marketplace. It should be understood that these graphical user interfaces are merely exemplary and other requirements, criteria, options, selections may be provided without departing from the scope of this disclosure.

FIGS. 7B and 7C depict graphical user interfaces 700b and 700c presented to a user who desires to register and sign-up as a credentialed user, for example, a user who has clicked on credentialed user button 702 in FIG. 7A). The interfaces may enable the user to provide information to create a user id for use on/access to the website in section I for example. The interfaces may enable the user to provide personal information in sections II, III and IV, for example. The interfaces may enable the user to agree to uphold the tenants of Professional Journalists' Code of Ethics and the mission for journalists; pledge to avoid conflicts of interest, refuse gifts, favors, fees, free travel and special treatment; and shun secondary employment, political involvement (including making campaign donations of any kind), public office and service in community organizations; if they compromise or tend to compromise journalistic integrity; and/or swear other oaths by checking the check boxes in section V, for example. The interfaces may enable the user to provide a 10-year work history in section VI for example. The interfaces may enable the user to provide payment information in section VII, for example. The interfaces may enable a user to agree to abide by the universal terms of use agreement and privacy policy by checking check box 706, for example. The interfaces may enable a user to enter a verification code in box 708 to prevent automated submissions. A user may click on the Register button 710 after he/she has provided all the details and agreed to swear the oaths provided.

FIGS. 7D and 7E depict graphical user interfaces 700d and 700e presented to a user who desires to register and sign-up as a non-credentialed user (for example, a user who has clicked on non-credentialed user button 704 in FIG. 7A). The interfaces may enable the user create a user id for use on/access to the website in section I for example. The interfaces may enable the user to provide personal information in sections II, III, and IV, for example. The interfaces may enable the user to agree to abide by the non-credentialed user terms that they will not steal the work of others and that they will not copy, redistribute, share or otherwise violate copyright laws by allowing others to read, view or consume paid content from the marketplace without them first paying for it, and/or swear other oaths by checking the check boxes in section V, for example. The interfaces may enable a user to agree to abide by the universal terms of use agreement and privacy policy by checking box 712, for example. The interfaces may enable a user to enter a verification code in box 714 to prevent automated submissions. A user may click on the Register button 716 after he/she has provided all the details and agreed to swear the oaths provided.

It will be understood the graphical user interfaces in FIGS. 7A-7E are exemplary and represent one particular implementation of the invention as described above, although other implementations and variations may be made thereto, as would be apparent, without departing from the scope or spirit of the invention.

Implementations of the invention may be made in hardware, firmware, software, or various combinations thereof. The invention may also be implemented as computer-readable instructions stored on a computer-readable storage medium which may be read and executed by one or more processors. A computer-readable storage medium may include various mechanisms for storing information in a form readable by a computing device. For example, a computer-readable storage medium may include read only memory, random access memory, magnetic disk storage media, optical storage media, flash memory devices, and/or other storage mediums. Further, firmware, software, routines, or instructions may be described in the above disclosure in terms of specific exemplary aspects and implementations of the invention, and performing certain actions. However, it will be apparent that such descriptions are merely for convenience, and that such actions may in fact result from computing devices, processors, controllers, or other devices executing firmware, software, routines or instructions.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system for an online standards-based journalism marketplace comprising a computer-readable storage medium, the computer-readable storage medium comprising one or more computer-readable instructions which when executed by a processor cause the processor to:
perform a credentialed user registration and credentialing process, wherein the one or more computer-executable instructions causing the processor to perform the credentialed user registration and credentialing process include one or more instructions causing the processor to:
obtain personal information, work history information and payment information from a user who desires to register as a credentialed user;
determine whether the user who desires to register as a credentialed user has agreed to uphold the tenants of Professional Journalists° Code of Ethics; and
in response to a determination that the user who desires to register as a credentialed user has agreed to uphold the tenants of Professional Journalists' Code of Ethics, register the user as a credentialed user.

2. The system of claim 1, wherein the one or more computer-readable instructions causing the processor to perform the credentialed user registration and credentialing process further include instructions causing the processer to:
determine whether the user who desires to register as a Credentialed user has accepted to abide by a universal terms of use agreement and privacy policy in response to a determination that the user who desires to register as a credentialed user has agreed to uphold the tenants of Professional Journalists' Code of Ethics; and
in response to a determination that the user who desires to register as a credentialed user has accepted to abide by the universal terms of use agreement and privacy policy, register the user as the credentialed user.

3. The system of claim 1, wherein the one or more computer-readable instructions further cause the processor to:
create a credentialed user account based on the obtained personal information, work history information and payment information;
verify an identity of the user registered as the credentialed user based on at least the obtained personal information and payment information; and
activate the credentialed user account in response to a successful identity verification.

4. The system of claim 1, wherein the one or more instructions further cause the processer to:
perform a non-credentialed user registration process in response to a determination that a user desires to register as a non-credentialed user, wherein the one or more computer-executable instructions causing the processor to perform the non-credentialed user registration process include one or more instructions causing the processor to:
obtain personal information from the user who desires to register as a non-credentialed user;
determine whether the user who desires to register as a non-credentialed user has accepted to abide by non-credentialed user terms;
in response to a determination that the user who desires to register as a non-credentialed user has accepted to abide the non-credentialed user terms, register the user as a non-credentialed user.

5. The system of claim 4, wherein the one or more computer-readable instructions causing the processor to perform the non-credentialed user registration process further include instructions causing the processer to:
determine whether the user who desires to register as a non-credentialed user has accepted to abide by a universal terms of use agreement and privacy policy in response to a determination that the user who desires to register as a non-credentialed user has accepted to abide by non-credentialed user terms;
in response to a determination that the user has accepted to abide by the universal terms of use agreement and privacy policy, register the user as the non-credentialed user.

6. The system of claim 4, wherein the one or more instructions further cause the processor to:
create a non-credentialed user account based on the obtained personal information; and
activate the non-credentialed user account.

7. A computer-implemented method for participating in an online standards-based journalism marketplace, the method comprising a plurality of operations performed by a processor, the plurality of operations comprising:
determining whether a user desires to register as a credentialed user or a non-credentialed user;
performing a credentialed user registration process in response to a determination that the user desires to register as a credentialed user, wherein said performing the credentialed user registration process comprises:
obtaining personal information, work history information and payment information from the user who desires to register as a credentialed user;
determining whether the user who desires to register as a credentialed user has agreed to uphold the tenants of Professional Journalists° Code of Ethics; and
in response to a determination that the user who desires to register as a credentialed user has agreed to uphold the tenants of Professional Journalists' Code of Ethics, registering the user as a credentialed user.

8. The method of claim 7, wherein said performing the credentialed user registration process further includes:
determining whether the user who desires to register as a credentialed user has accepted to abide by a universal terms of use agreement and privacy policy in response to a determination that the user who desires to register as a credentialed user has agreed to uphold the tenants of Professional Journalists' Code of Ethics; and
in response to a determination that the user who desires to register as a credentialed user has accepted to abide by the universal terms of use agreement and privacy policy, registering the user as the credentialed user.

9. The method of claim 7, further comprising:
creating a credentialed user account based on the obtained personal information, work history information and payment information;
verifying an identity of the user registered as the credentialed user based on at least the obtained personal information and the payment information; and
activating the credentialed user account in response to a successful identity verification.

10. The method of claim 7, further comprising:
performing a non-credentialed user registration process in response to a determination that the user desires to register as a non-credentialed user, wherein said performing the non-credentialed user registration process comprises:
obtaining personal information from the user who desires to register as a non-credentialed user;
determining whether the user who desires to register as a non-credentialed user has accepted to abide by non-credentialed user terms;
in response to a determination that the user who desires to register as a non-credentialed user has accepted to abide the non-credentialed user terms, registering the user as a non-credentialed user.

11. The method of claim 10, wherein the performing the non-credentialed user registration process further includes:
determining whether the user who desires to register as a non-credentiated user has accepted to abide by a universal terms of use agreement and privacy policy in response to a determination that the user who desires to register as a non-credentialed user has accepted to abide by non-credentialed user terms;
in response to a determination that the user has accepted to abide by the universal terms of use agreement and privacy policy, registering the user as the non-credentialed user.

12. The method of claim 10, further comprising:
creating a non-credentialed user account based on the obtained personal information; and
activating the non-credentialed user account.
